(19) United States
(12) Patent Application Publication
(10) Pub. No.: US 2005/0147000 A1
(43) Pub. Date: Jul. 7, 2005

(54) Actuator for optical pickup, optical pickup, and optical recording/reproducing apparatus employing the same

(75) Inventors: Seok-jung Kim, Suwon-si (KR); Young-man Ahn, Suwon-si (KR); Kwang Kim, Suwon-si (KR); Tae-kyung Kim, Seoul (KR); Jung-gug Pae, Suwon-si (KR); Tae-youn Heor, Suwon-si (KR); Chong-sam Chung, Hwaseong-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/998,172

(22) Filed: Nov. 29, 2004

(30) Foreign Application Priority Data
Dec. 30, 2003 (KR) 2003-100547

(51) Int. Cl. G11B 7/00

(52) U.S. Cl. 369/44.15; 369/44.22

(57) ABSTRACT

An optical pickup actuator having: a moving part on which an objective lens to focus an incident beam onto an optical recording medium is mounted, a magnetic driver that drives the moving part in track and focus directions of the optical recording medium, and a support element that movably supports the moving part and has a first support portion with a first predetermined stiffness and a second support portion with a second predetermined stiffness different from the first predetermined stiffness. A center of gravity of the moving part, a center of support of the support element, and a center of a force determined by arrangement of the magnetic driver are coincident.

### CROSS-REFERENCE TO RELATED APPLICATIONS

This application claims the benefit of Korean Patent Application No. 2003-100547, filed on Dec. 30, 2003, in the Korean Intellectual Property Office, the disclosure of which is incorporated herein by reference.

### BACKGROUND OF THE INVENTION

1. Field of the Invention

The present invention relates to an actuator for an optical pickup that controls motion of an objective lens in focus and tracking directions, an optical pickup, and an optical recording/reproducing apparatus employing the same, and more particularly, to an optical pickup actuator constructed such that a center of support and a center of a force coincide with a center of gravity of a moving part, and an optical pickup, and an optical recording/reproducing apparatus employing the same.

2. Description of the Related Art

An optical pickup is used in an optical recording and/or reproducing apparatus to perform non-contact recording and/or reproducing of information on and/or from an optical disc that is an optical information storage medium, while moving in a radial direction of the optical disc. The optical pickup has an objective lens that focuses a beam emitted by a light source to a beam spot on the disc. The objective lens is mounted on an optical pickup actuator, and moves in a track direction and a focus direction so that the beam spot is positioned on the disc. The actuator is designed to accurately move the objective lens to a desired location due to electromagnetic interaction among a permanent magnet, a focus coil, and a track coil.

To improve the frequency characteristics of an actuator by minimizing subsidiary resonance or rolling of a moving part during operation, the actuator should be designed so that a center of gravity in the moving part, a center of support of wires, and a center of a force in a magnetic driver can be coincident with one another.

Increasing demands for high density recording and reproducing requires the use of an objective lens with a high numerical aperture (NA) and a short working distance, which is the distance between the objective lens and the disc. Thus, an actuator having a symmetrical structure needs a moving part with a projecting objective lens. Accordingly, it is very hard to make the center of gravity, the center of support, and the center of a force coincident with one another in a focus direction.

Considering this point, a conventional optical pickup actuator is constructed such that the three centroids coincide with one another. To this end, the center of gravity is moved by measuring the weight of a moving part with respect to the center of support and the center of the force, and then modifying the shape of a portion of the moving part based on the measurement result. However, this not only increases the weight of the moving part, but also makes it difficult to employ in an optical pickup actuator subjected to a height constraint.

To make the three centroids coincide with one another, another conventional optical pickup actuator has a separate element, such as a brass plate, with a higher density than the moving part or the objective lens, attached to a lower end of the moving part. But adding this separate element increases manufacturing costs and a number of assembling operations. Furthermore, a height constraint imposed on the moving part makes it difficult to employ in an optical pickup for high density recording/reproducing.

### SUMMARY OF THE INVENTION

The present invention provides an optical pickup actuator constructed to move a center of support and a center of a force by adjusting stiffness of a support element and coil arrangement, thus, in conjunction with a center of gravity, making three centroids coincident without adding a separate component, and an optical pickup, and an optical recording/reproducing apparatus employing the optical pickup actuator.

According to an aspect of the present invention, there is provided an optical pickup actuator including a moving part on which an objective lens to focus an incident beam onto an optical recording medium is mounted, a magnetic driver that drives the moving part in track and focus directions of the optical recording medium, and a support element that movably supports the moving part and includes a first support portion having a first predetermined stiffness and a second support portion having a second predetermined stiffness different from the first predetermined stiffness. A center of gravity of the moving part, a center of support of the support element, and a center of a force determined by arrangement of the magnetic driver are coincident.

According to another aspect of the present invention, there is provided an optical pickup including: an optical unit that has a light source that emits a laser beam, an objective lens that focuses the laser beam onto an optical recording medium, and a photodetector that receives a beam reflected from the optical recording medium to detect an information signal and an error signal, and records information and/or reproduces information on and/or from the optical recording medium; and an actuator that has a moving part on which the objective lens is mounted, a magnetic driver that drives the moving part in track and focus directions of the optical recording medium, and a support element that movably supports the moving part and controls the objective lens in the focus and track directions based on the error signal detected by the photodetector. The support element comprises a first predetermined stiffness and a second support portion having a second predetermined stiffness different from the first predetermined stiffness. A center of gravity of the moving part, a center of support of the support element, and a center of a force determined by arrangement of the magnetic driver coincide with one another.

According to another aspect of the present invention, there is provided an optical recording/reproducing apparatus including: a driving source on which an optical recording medium is seated, and which spins the optical recording medium, an optical unit that has a light source that emits a laser beam, an objective lens that focuses the laser beam onto the optical recording medium, and a photodetector that receives a beam reflected from the optical recording medium to detect an information signal and an error signal, and records information and/or reproduces information on and/or from the optical recording medium, and an actuator that has a moving part on which the objective lens is mounted, a magnetic driver that drives the moving part in track and focus directions of the optical recording medium, and a support element that movably supports the moving part and controls the objective lens in the focus and track directions based on the error signal detected by the photodetector. The support element comprises a first predetermined stiffness and a second support portion having a second predetermined stiffness different from the first predetermined stiffness. A center of gravity of the moving part, a center of support of the support element, and a center of a force determined by arrangement of the magnetic driver coincide with one another.

Additional aspects and/or advantages of the invention will be set forth in part in the description which follows, and in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a schematic perspective view of an optical pickup actuator according to an embodiment of the present invention;

FIG. 2 is a schematic side view of the optical pickup actuator of FIG, 1;

FIG. 3 is a schematic plan view of the optical pickup actuator of FIG. 1;

FIGS. 4-6 are schematic diagrams showing magnetic drivers according to embodiments of the present invention, respectively;

FIG. 7 is a schematic diagram of an optical pickup according to an embodiment of the present invention; and

FIG. 8 is a schematic diagram of an optical recording/reproducing apparatus employing an optical pickup actuator and an optical pickup according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

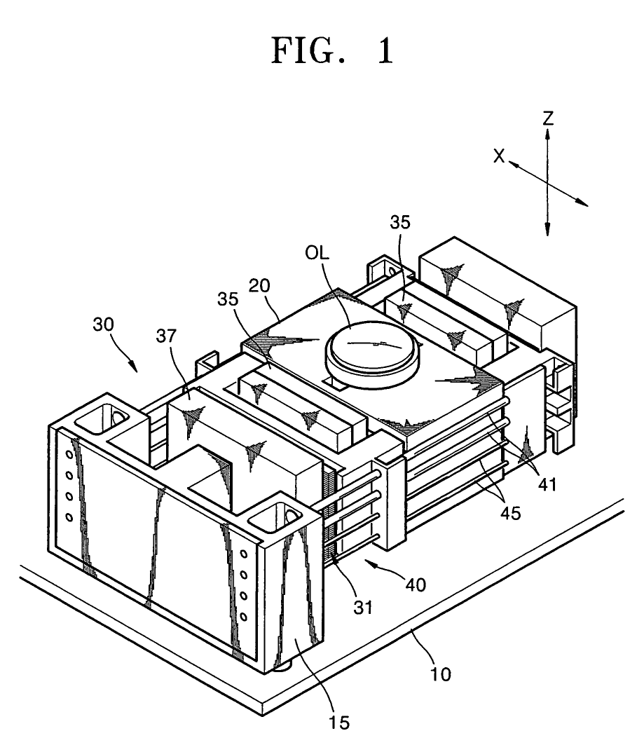

Referring to FIGS. 1-3, an optical pickup actuator according to an embodiment of the present invention includes a base 10, a holder 15 mounted on one side of the base 10, a moving part 20 mounted to be movable in X-axis and Z-axis directions, a magnetic driver 30 that magnetically drives the moving part 20, and a support element 40 that supports the moving part 20, so that the moving part 20 is movable with respect to the holder 15 and is used as a conducting path.

An objective lens OL is mounted on the moving part 20 and focuses an incident beam onto an optical recording medium D having a high density. In this case, to achieve a high numerical aperture (NA) and a short working distance to meet demands for the high density optical recording medium D, the objective lens OL projects out from the moving part 20 in the optical pickup actuator having a symmetrical structure, as is shown in FIG. 1. Thus, a center C of gravity in the moving part 20, on which the objective lens OL is mounted, is biased upward from a center of the moving part 20. According to one embodiment, the optical pickup actuator further includes a cover 50 that protects the moving part 20 and prevents the objective lens OL from colliding with the optical recording medium D.

The magnetic driver 30 drives the moving part 20 in radial (X-axis) and focus (Z-axis) directions of the optical recording medium D. The magnetic driver 30 includes coils 31 disposed on two opposite sides of the moving part 20, and magnets 35 and yokes 37 that are disposed on the base 10 and oppose the coils 31. Thus, the moving part 20 is driven in the focus and track directions due to an electromagnetic force generated between the coils 31 and the magnets 35. Various embodiments of magnetic drivers will be described later.

In general, if the moving part 20 is supported by a plurality of wires installed on one side thereof, a portion of the moving part 20 supported corresponds to a center of support in the wires. For example, if the moving part 20 is supported by two wires having equal stiffness disposed on one side thereof, a point of support corresponding to half spacing between the two wires is the center of support. If the two wires have different stiffnesses, the center of support is shifted toward the wire with greater stiffness. Additionally, the center of a force of the magnetic driver 30 represents the center of an electromagnetic force exerted between coils and magnets of the magnetic driver 30. For example, if a track coil, a focus coil, and magnets are symmetrically arranged about the center of the moving part, the center of the moving part becomes the center of the force. And if the track coil, focus coil, and magnets are eccentrically disposed, the center of the force moves toward the direction of eccentricity.

Referring again to FIGS. 1-3, the support element 40 is symmetrically disposed on the other two opposite sides of the moving part 20, and supports the moving part 20 that is movable with respect to the holder 15. The support element 40 is also used as a conducting path to apply current to the coils 31. The support element 40 includes a first support portion 41 that supports an upper portion of the moving part 20, and a second support portion 45 that is disposed below the first support portion 41 and supports a lower portion thereof. Here, since the first and second support portions 41 and 45 have different stiffnesses, a position of the center of support in the moving part 20 can be adjusted so that it is coincident with the center C of gravity.

To this end, according to one embodiment, wire diameters (thicknesses) or materials of the first and second support portions 41 and 45 are determined so that the first support portion 41 has a greater stiffness than the second support portion 45.

Thus, the stiffnesses of the first and second support portions 41 and 45 vary depending on the thicknesses and materials of wires 41a and 41b and wires 45a and 45b of the first and second support portions 41 and 45, respectively. Thus, the first and second support portions 41 and 45 can have different stiffnesses by varying the thicknesses of the wires 41a and 41b and 45a and 45b.

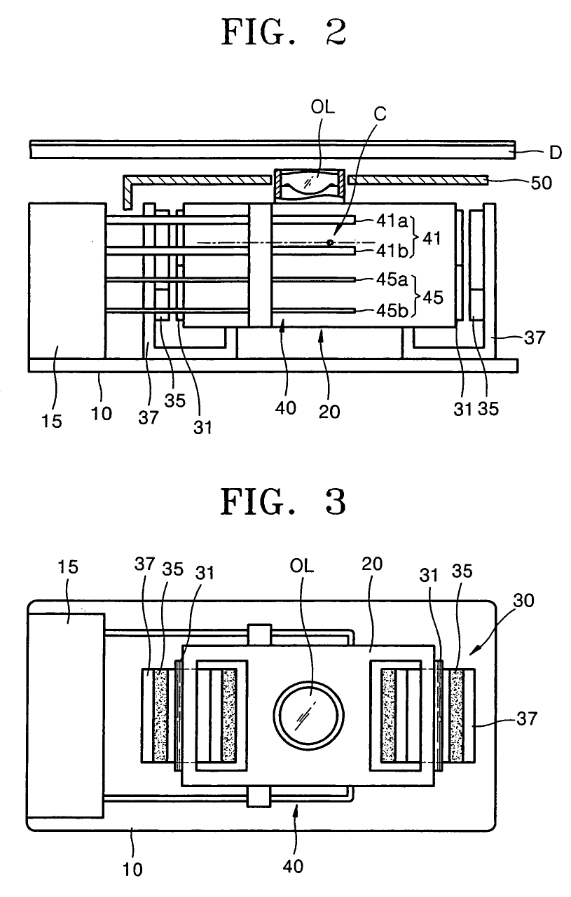

According to one embodiment, the first support portion 41 comprises two or more wires. In an embodiment with two wires, the wires are symmetrically disposed on opposing sides of the moving part 20. FIGS. 1 and 2 show an embodiment in which the first support portion 41 has four wires 41a and 41b, two being disposed on each opposing side of the moving part 20. The second support portion 45 is disposed below the first support portion 41 and comprises two or more wires. In an embodiment containing two wires, the wires are symmetrically disposed on opposing sides of the moving part 20. FIGS. 1 and 2 how an embodiment in which the second support portion 45 has four wires 45a and 45b, two being disposed on each opposing side of the moving part 20.

In FIGS. 1-3, the plurality of wires 41a, 41b, 45a, and 45b are symmetrically disposed on opposing sides of the moving part 20. Thus the support element 40 symmetrically supports the movable part 20, and suppresses rolling and subsidiary resonance during operation. Accordingly, the support element 40 can be adjusted the center of support coincides with the center C of gravity in the moving part 20, without the need for a separate element to move the center of support.

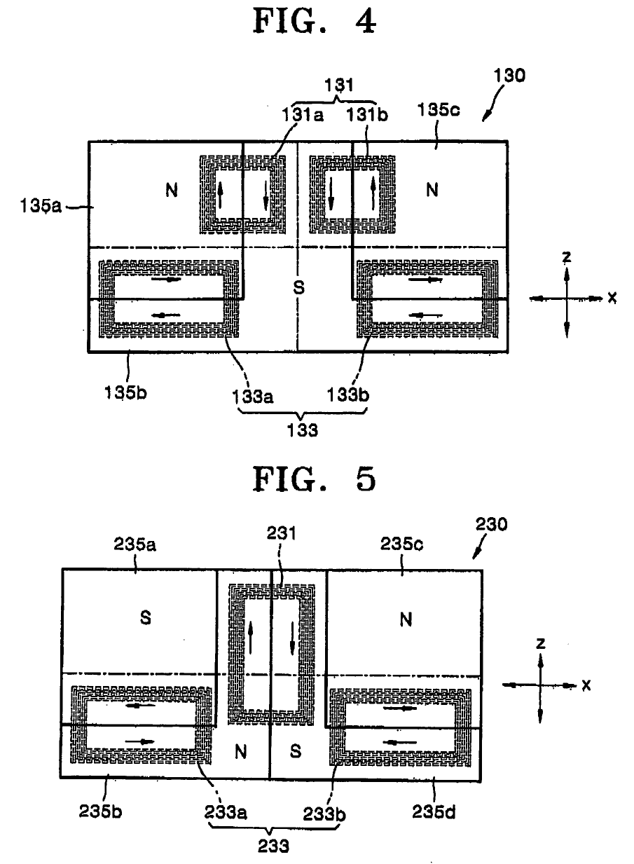

Magnetic drivers of the optical pickup actuator according to embodiments of the present invention and a center of a magnetic driving force will now be described with references to FIGS. 4-6. FIGS. 4-6 illustrate arrangement of a magnet opposite each coil and magnetic polarities when the magnet and the coil are in the same plane. In these embodiments, current flows through each coil in directions indicated by arrows, and indicated polarities represent polarities of portions of the magnet opposite each coil.

Referring to FIG. 4, a magnetic driver 130 according to an embodiment of the present invention includes a plurality of coils 131 and 133 attached to a moving part, and a plurality of magnets 135a-135c that generate a driving force due to interaction with current flowing through the coils 131 and 133. A track coil 131 drives the moving part in a track direction, i.e. X-axis direction, and a focus coil 133 drives the same in a focus direction, i.e. Z-axis direction. The track and focus coils 131 and 133 are made from fine pattern coils, and are disposed in parallel planes on opposing sides of the moving part.

The track coil 131 comprises first and second track coils 131a and 131b symmetrically disposed about a central line parallel to the Z-axis direction. The focus coil 133 comprises first and second focus coils 133a and 133b disposed symmetrically about the central line in a radial direction of the optical recording medium D. Thus, considering a horizontal arrangement of the coils 131 and 133 on the moving part, the center of an electromagnetic force is located at the center of the moving part. But considering a vertical arrangement of the coils 131 and 133 on the moving part, the center of an electromagnetic force is located away from the center of the moving part, since the coils 131 and 133 are arranged in the same plane.

In the illustrated embodiments of FIGS. 1-4, the center of support and the center of the electromagnetic force are made coincident with the center of gravity in the moving part, which deviates from the center of the moving part. Thus, although the center of the electromagnetic force is located away from the center of the moving part due to arrangement of the track coil 131 and the focus coil 133 in the same plane, the center of the force can be made coincident with the center of gravity.

As is shown in FIG. 4, the illustrated magnet comprises first through third magnets 135a-135c. While the first and third magnets 135a and 135c have the same magnetic polarity, the second magnet 135b has an opposite magnetic polarity. Here, centers of the first and second track coils 131a and 131b are located at boundaries (track boundaries) between the first and second magnets 135a and 135b and between the second and third magnets 135b and 135c, respectively, the boundaries being parallel to the Z-axis direction. Thus, portions of the first and second track coils 131a and 131b, which are vertically oriented, are used to generate a driving force in the track direction. By passing current through the first and second track coils 131a and 131b in opposite directions, it is possible to drive the moving part in the track direction (X-axis direction). When the magnet is arranged and current flows in the track coils 131a and 131b, as shown in FIG. 4, the moving part is driven in a negative X-axis direction, while when the direction of current is reversed, the moving part is driven in a positive X-axis direction.

Centers of the first and second focus coils 133a and 133b are located at boundaries (focus boundaries) between the first and second magnets 135a and 135b and between the second and third magnets 135b and 135c, respectively, the boundaries being parallel to the X-axis direction. Portions of the first and second focus coils 133a and 133b, which are horizontally oriented, are used to generate a driving force in the focus direction. Thus, by passing current through the first and second focus coils 133a and 133b in same directions, it is possible to drive the moving part in the focus direction (Z-axis direction). When the magnet is arranged and current flows in the focus coils 133a and 133b, as shown in FIG. 4, the moving part is driven in a positive Z-axis direction, while when the direction of current is reversed, the moving part is driven in a negative Z-axis direction.

Referring to FIG. 5, a magnetic driver 230 according to another embodiment includes a plurality of coils 231 and 233 attached to a moving part, and a plurality of magnets 235a-235d that generate a driving force due to interaction with current flowing through the coils of the plurality of coils 231 and 233 comprise a track coil 231, and a focus coil 233. The track and focus coils 231 and 233 are made from fine pattern coils, and are disposed in parallel planes on opposing sides of the moving part.

The track coil 231 comprises a single coil disposed symmetrically relative to a central line parallel to the Z-axis direction. The focus coil 233 comprises first and second focus coils 233a and 233b disposed symmetrically about the central line in a radial direction of the optical recording medium D. Thus, considering a horizontal arrangement of the coils 231 and 233 on the moving part, the center of an electromagnetic force is located at the center of the moving part. But considering a vertical arrangement of the coils 231 and 233 on the moving part, the center of the electromagnetic force deviates from the center of the moving part, since the coils 231 and 233 are arranged in the same plane.

As is shown in FIG. 5, the illustrated magnet comprises first through fourth magnets 235a-235d. While the first and fourth magnets 235a and 235d have the same magnetic polarity, the second and third magnets 235b and 235c have a magnetic polarity opposite that of the first and fourth magnets 235a and 235d. Here, a center of the track coil 231 is located at a boundary (track boundary) between the second and fourth magnets 235b and 235d parallel to the Z-axis direction. Thus, a portion of the track coil 231, which is vertically oriented, is used to generate a driving force in the track direction. When the magnet is arranged and current flows in the track coil 231, as shown in FIG. 5, the moving part is driven in a negative X-axis direction, while when the direction of current is reversed, the moving part is driven in a positive X-axis direction.

Centers of the first and second focus coils 233a and 233b are located at boundaries (focus boundaries) between the first and second magnets 235a and 235b, and between the third and fourth magnets 235c and 235d, respectively, the boundaries being parallel to the X-axis direction. Portions of the first and second focus coils 233a and 233b, which are horizontally oriented, are effectively used to generate a driving force in the focus direction. Thus, by passing current through the first and second focus coils 233a and 233b in opposite directions, it is possible to drive the moving part in the focus direction (Z-axis direction). When the magnet is arranged and current flows in the focus coils 233a and 233b, as shown in FIG. 5, the moving part is driven in a negative Z-axis direction, while when the direction of current is reversed, the moving part is driven in a positive Z-axis direction.

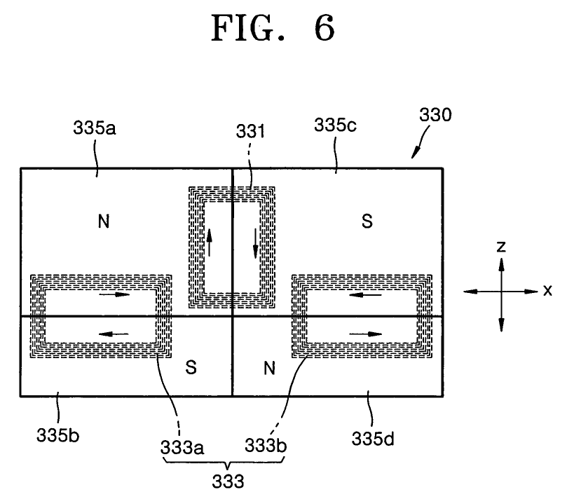

Referring to FIG. 6, a magnetic driver 330 according to yet another embodiment includes a plurality of coils 331 and 333 attached to a moving part, and a plurality of magnets 335a-355d that generate a driving force due to interaction with current flowing through the coils. The plurality of coils 331 and 333 comprises a track coil 331 and a focus coil 333. The track and focus coils 331 and 333 are made from fine pattern coils, and are disposed in parallel planes on opposing sides of the moving part.

The track coil 331 comprises a single coil disposed symmetrically relative to a central line parallel to the Z-axis direction. The focus coil 333 comprises first and second focus coils 333a and 333b disposed symmetrically about the central line in a radial direction of the optical recording medium D. Thus, considering a horizontal arrangement of the coils 331 and 333 on the moving part, a center of an electromagnetic force is located at a center of the moving part. But considering a vertical arrangement of the coils 331 and 333 on the moving part, the center of the electromagnetic force deviates from the center of the moving part, since the coils 331 and 333 are arranged in the same plane.

As is shown in FIG. 6, the illustrated magnet comprises first through fourth magnets 335a-335d. While the first and third magnets 335a and 335c have the same magnetic polarity, the second and fourth magnets 335b and 335d have a magnetic polarity opposite that of the first and third magnets 335a and 335c. The magnet in this embodiment is divided into four parts like that shown in FIG. 5 but differs in that the first through fourth magnets 335a-335d each have a rectangular shape.

A center of the track coil 331 is located at a boundary (track boundary) between the first and third magnets 335a and 335c parallel to the Z-axis direction. A portion of the track coil 231, which is vertically oriented, is used to generate a driving force in the track direction. When the magnet is arranged and current flows in the tracking coil 331, as shown in FIG. 6, the moving part is driven in a positive X-axis direction, while when the direction of current is reversed, the moving part is driven in a negative X-axis direction.

Centers of the first and second focus coils 333a and 333b are located at boundaries (focus boundaries) between the first and second magnets 335a and 335b, and between the third and fourth magnets 335c and 335d, respectively, the boundaries being parallel to the X-axis direction. Portions of the first and second focus coils 333a and 333b, which are horizontally oriented, are used to generate a driving force in the focus direction. Thus, by passing current through the first and second focus coils 333a and 333b in opposite directions, it is possible to drive the moving part in the focus direction (Z-axis direction). When the magnet is arranged and current flows in the focus coils 333a and 333b, as shown in FIG. 6, the moving part is driven in a positive Z-axis direction, while when the direction of current is reversed, the moving part is driven in a negative Z-axis direction.

As is described above, each of the magnetic drivers 130, 230, and 330 is constructed so that the track coil and the focus coil, made from fine pattern coils, can be arranged in the same plane. Furthermore, despite arrangement of the coils in the same plane, each magnetic driver 130, 230, and 330 allows the respective centers of the respective generated electromagnetic forces to coincide with the center of gravity located away from the center of the moving part.

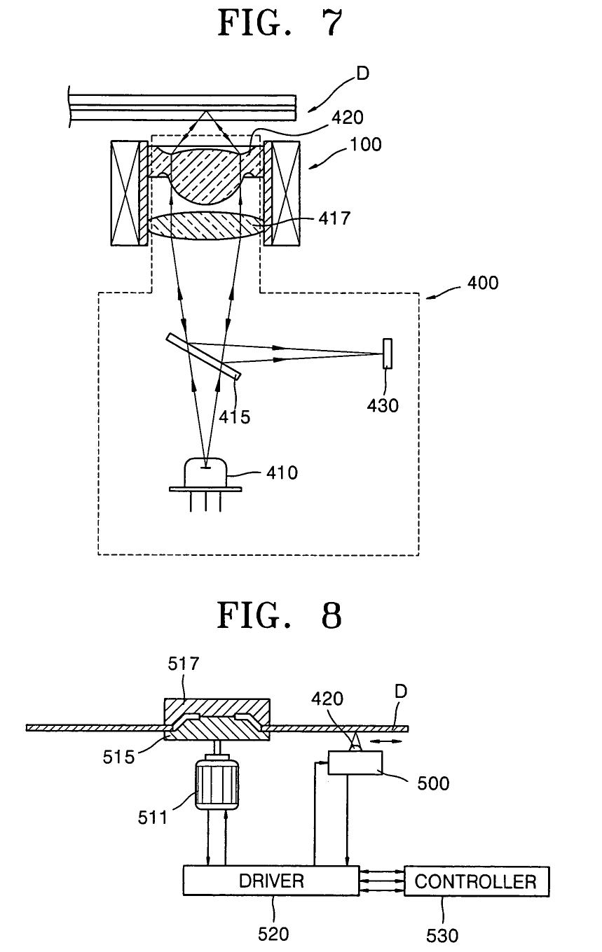

Referring to FIG. 7, an optical pickup according to still yet another embodiment of the present invention includes an optical unit 400 that records information and/or reproduces information on and/or from an optical recording medium D, and an actuator 100 that controls the optical unit 400 in track and focus directions.

The optical unit 400 comprises a light source 410 that emits a laser beam, an objective lens 420 that focuses the beam emitted by the light source 410, and a photodetector 430 that receives a beam reflected from the optical recording medium D to detect an information signal and an error signal. The objective lens 420 is mounted on the moving part (20 of FIG. 1) of the actuator 100, and operates to correct track and focus errors. The optical unit 400 further includes a beam splitter 415 that is disposed in an optical path between the light source 410 and the objective lens 420, and converts the propagation path of an incident beam, so that an effective beam emitted by the light source 410 travels toward the optical recording medium D, and an effective beam reflected from the optical recording medium D travels toward the photodetector 430. According to one embodiment, the optical unit 400 further includes a collimating lens 417 that collimates the beam incident on the objective lens 420 into a parallel beam. The actuator 100 controls the position of the objective lens 420 in the focus and track directions based on the error signal detected by the photodetector 430. Since the actuator 100 has substantially the same construction as described with references to FIGS. 1-6, a detailed explanation thereof is omitted.

FIG. 8 is a schematic diagram of an optical recording/reproducing apparatus employing an optical pickup according to an embodiment of the present invention. Referring to FIG. 8, the optical recording/reproducing apparatus includes: a driving source 511 that provides a rotary force; a turntable 515 that is fixed to a rotating axis of the driving source 511, and on which the optical recording medium D is seated; a clamp 517 that fixes the optical recording medium D seated on the turntable 515; an optical pickup 500 that is installed movably along a radial direction of the optical recording medium D and records information and/or reproduces information on and/or from the optical recording medium D; a driver 520 that drives the driving source 511 and the optical pickup 500; and a controller 530 that controls focus and track servos of the optical pickup 500. The optical pickup 500 includes the optical unit (400 of FIG. 7) with the objective lens 420 and the actuator (100 of FIG. 7) that drives the objective lens 420 in focus and track directions.

The optical recording/reproducing apparatus has an optical pickup, in particular, an actuator with an improved structure. Since the construction and operation of the optical pickup and the actuator are substantially the same as those described with references to FIGS. 1-7, a detailed description thereof is omitted.

In the optical recording/reproducing apparatus, a signal detected and subjected to photoelectrical conversion by the optical pickup 500 is input to the controller 530 through the driver 520. The driver 520 controls the rotating speed of the driving source 511, and drives the optical pickup 500. The controller 530 sends focus servo and track servo commands, which have been adjusted based on the signal received from the driver 520, back to the driver 520 so that the optical pickup 500 can perform focus and tracking servo operations.

An optical pickup actuator, an optical pickup, and an optical recording/reproducing apparatus enable the center of support and the center of a force to coincide with the center of gravity, located away from the center of a moving part, by adjusting the stiffness of a support element without adding a separate component, thereby minimizing rolling and subsidiary resonance exhibited during operation of the actuator.

Although a few embodiments of the present invention have been shown and described, it would be appreciated by those skilled in the art that changes may be made in these embodiments without departing from the principles and spirit of the invention, the scope of which is defined in the claims and their equivalents.

1. An optical pickup actuator comprising:
a moving part on which an objective lens to focus an incident beam onto an optical recording medium is mounted;
a magnetic driver that drives the moving part in track and focus directions of the optical recording medium; and
a support element that movably supports the moving part and includes a first support portion having a first predetermined stiffness and a second support portion having a second predetermined stiffness different from the first predetermined stiffness,
wherein a center of gravity of the moving part, a center of support of the support element, and a center of a force determined by arrangement of the magnetic driver are coincident.

2. The optical pickup actuator of claim 1, wherein the first and second support portions have different stiffnesses due to a difference in at least one of thickness or material composition.

3. The optical pickup actuator of claim 1, wherein the first predetermined stiffness is greater than the second predetermined stiffness.

4. The optical pickup actuator of claim 1, wherein the support element comprises a plurality of wires disposed on first and second opposing sides of the moving part, at least one of the wires on the first side having the same stiffness as at least one of the wires disposed on the second side.

5. The optical pickup actuator of claim 1, wherein the magnetic driver comprises:
focus and track coils attached to the moving part; and
a plurality of magnets that generate an electromagnetic force acting to drive the moving part in the focus and track directions of the optical recording medium due to interaction with current flowing through the focus and track coils.

6. The optical pickup actuator of claim 5, wherein:
the focus and track coils are made from fine pattern coils; and
the focus and track coils are disposed in a first plane on a first side of the moving part and a second plane on a second side of the moving part opposite the first side.

7. The optical pickup actuator of claim 6, wherein:
the focus coils are disposed symmetrically with respect to the moving part in the first and second planes, respectively; and
the respective focus coils each comprise first and second focus coils disposed symmetrically relative to a center of the moving part in a radial direction of the optical recording medium.

8. The optical pickup actuator of claim 6, wherein:
the track coils are symmetrically disposed one of above or below the focus coils with respect to the moving part in the first and second planes, respectively; and
the respective track coils each comprise first and second track coils disposed symmetrically relative to a center of the moving part in a radial direction of the optical recording medium.

9. An optical pickup comprising:
an optical unit that includes:
a light source that emits a laser beam,
an objective lens that focuses the laser beam onto an optical recording medium, and
a photodetector that receives a beam reflected from the optical recording medium to detect an information signal and an error signal, and records information and/or reproduces information on and/or from the optical recording medium; and
an actuator that includes:
a moving part on which the objective lens is mounted,
a magnetic driver that drives the moving part in track and focus directions of the optical recording medium, and
a support element that movably supports the moving part and controls the objective lens in the focus and track directions based on the error signal detected by the photodetector,
wherein the support element comprises:
a first support portion having a first predetermined stiffness, and
a second support portion having a second predetermined stiffness different from the first predetermined stiffness, and
wherein a center of gravity of the moving part, a center of support of the support element, and a center of a force determined by arrangement of the magnetic driver are coincident.

10. The optical pickup of claim 9, wherein the first and second support portions have different stiffnesses due to a difference in at least one of thickness or material composition.

11. The optical pickup of claim 9, wherein the first predetermined stiffness is greater than the second predetermined stiffness.

12. The optical pickup of claim 9, wherein the support element comprises a plurality of wires disposed on first and second opposing sides of the moving part, at least one of the wires on the first side having the same stiffness as at least one of the wires disposed on the second side.

13. The optical pickup of claim 9, wherein the magnetic driver comprises:
focus and track coils attached to the moving part; and
a plurality of magnets that generate an electromagnetic force acting to drive the moving part in the focus and track directions of the optical recording medium due to interaction with current flowing through the focus and track coils.

14. The optical pickup of claim 13, wherein:
the focus and track coils are made from fine pattern coils; and
the focus and track coils are disposed in a first plane on a first side of the moving part and a second plane on a second side of the moving part opposite the first side.

15. The optical pickup of claim 14, wherein:
the focus coils are disposed symmetrically with respect to the moving part in the first and second planes, respectively; and
the respective focus coils each comprise first and second focus coils disposed symmetrically relative to a center of the moving part in a radial direction of the optical recording medium.

16. The optical pickup of claim 14, wherein:
the track coils are symmetrically disposed one of above or below the focus coils with respect to the moving part in the first and second planes, respectively; and
the respective track coils each comprise first and second track coils disposed symmetrically relative to a center of the moving part in a radial direction of the optical recording medium.

17. An optical recording/reproducing apparatus comprising:
a driving source on which an optical recording medium is seated, and which spins the optical recording medium;
an optical unit that includes:
a light source that emits a laser beam,
an objective lens that focuses the laser beam onto the optical recording medium, and
a photodetector that receives a beam reflected from the optical recording medium to detect an information signal and an error signal, and records information and/or reproduces information on and/or from the optical recording medium; and
an actuator that includes:
a moving part on which the objective lens is mounted,
a magnetic driver that drives the moving part in track and focus directions of the optical recording medium, and
a support element that movably supports the moving part and controls the objective lens in the focus and track directions based on the error signal detected by the photodetector,
wherein the support element comprises:
a first support portion having a first predetermined stiffness, and
a second support portion having a second predetermined stiffness different from the first predetermined stiffness, and
wherein a center of gravity of the moving part, a center of support of the support element, and a center of a force determined by arrangement of the magnetic driver are coincident.

18. The apparatus of claim 17, wherein:
the first and second support portions have different stiffnesses due to a difference in at least one of thickness or material composition; and
the support element comprises a plurality of wires disposed on first and second opposing sides of the moving part, at least one of the wires on the first side having the same stiffness as at least one of the wires disposed on the second side.

19. The apparatus of claim 17, wherein:
the magnetic driver comprises:
focus and track coils attached to the moving part; and
a plurality of magnets that generate an electromagnetic force acting to drive the moving part in the focus and track directions of the optical recording medium due to interaction with current flowing through the focus and track coils;
the focus and track coils are made from fine pattern coils; and
the focus and track coils are disposed in a first plane on a first side of the moving part and a second plane on a second side of the moving part opposite the first side.

20. The apparatus of claim 19, wherein:
the focus coils are disposed symmetrically with respect to the moving part in the first and second planes, respectively;
the respective focus coils each comprise first and second focus coils disposed symmetrically relative to a center of the moving part in a radial direction of the optical recording medium;
the track coils are symmetrically disposed one of above or below the focus coils with respect to the moving part in the first and second planes, respectively; and
the respective track coils each comprise first and second track coils disposed symmetrically relative to a center of the moving part in a radial direction of the optical recording medium.

21. An optical pickup actuator, comprising;
a moving part having an objective lens;
a support element movably connecting the moving part with a base; and
a magnetic driver exerting a force to move the moving part along focus and track axes of an optical storage medium,
a center of support of the support element is adjusted to coincide with a center of the force and a center of gravity of the moving part by adjusting a stiffness of the support element without adding a separate component, to minimize rolling and subsidiary resonance of the moving part during operation of the actuator.
